(19) United States
(12) Patent Application Publication
(10) Pub. No.: US 2019/0266565 A1
(43) Pub. Date: Aug. 29, 2019

(54) PROCESS DESIGN SUPPORT APPARATUS, PROCESS DESIGN SUPPORT METHOD, AND PROGRAM

(71) Applicant: NEC Corporation, Minato-ku, Tokyo (JP)

(72) Inventors: Mitsuteru TANOUE, Tokyo (JP); Kazutoshi YONEKURA, Tokyo (JP); Hajime EDA, Tokyo (JP)

(73) Assignee: NEC Corporation, Minato-ku, Tokyo (JP)

(21) Appl. No.: 16/346,589

(22) PCT Filed: Nov. 9, 2017
(86) PCT No.: PCT/JP2017/040415

§ 371 Date: May 1, 2019

(30) Foreign Application Priority Data
Nov. 11, 2016 (JP) 2016-220735

(51) Int. Cl. G06Q 10/08; G06Q 10/06; G06Q 10/10

(52) U.S. Cl. CPC G06Q 10/0875; G06Q 10/103; G06Q 10/06315

(57) ABSTRACT

A process design support apparatus includes: a part list storage part that holds a part list representing a part(s) included in a product; a process list storage part that holds a process list representing a process(es) included in a process sequence(s); and an association part that associates an item(s) included in the part list with an item(s) included in the process list.

### REFERENCE TO RELATED APPLICATION

The present invention is based upon and claims the benefit of the priority of Japanese patent application No. 2016-220735, filed on Nov. 11, 2016, the disclosure of which is incorporated herein in its entirety by reference thereto.

### FIELD

The present invention relates to a process design support apparatus, a process design support method, and a program. In particular, it relates to a process design support apparatus, a process design support method, and a program for supporting designing a BOP (Bills Of Process) that represents manufacturing processes of products.

### BACKGROUND

At “manufacturing” sites in the manufacturing industry, etc., PLM (product lifecycle management) software for integrally managing product technology information about design drawings, specifications, a part list, etc. has been in widespread use. Such PLM software includes a function of creating and managing a part list (BOM: Bills Of Material) including part-based configurations (or product structures) indicating kinds, quantities, etc. of parts included in a product. By integrally managing the product technology information based on the PLM software and allowing a plurality of departments (a development department, a production engineering department, a material department, a production management department, a manufacturing department, etc.) to share the related information, it is possible to bring new products to market more quickly and reduce costs.

PTL 1 as a related technique describes a technique for automatically generating a work sequence by referring to a table in which CAD (computer-aided design) information and process kinds (namely, kinds of processes) are associated with each other, extracting process kinds for manufacturing products from the CAD information about the products, and rearranging the process kinds by referring to a template representing a process sequence relationship.

### CITATION LIST

### Patent Literature

PTL 1: Japanese Patent Kokai Publication No. JP-2010-123105A

### SUMMARY

### Technical Problem

The entire content disclosed by PTL 1 is incorporated herein by reference thereto. The following analysis has been made by the present inventors.

“A part list (BOM: Bills Of Material)” is standard information about an individual product itself, the information representing “the kinds of parts and the number of parts of an individual kind” used to manufacture the product. As illustrated in FIG. 18(a), a designer creates an engineering BOM that represents the part-based configurations of a product by using CAD (computer-aided design), etc. In addition, as illustrated in FIG. 18(b), a production manager creates a manufacturing BOM by adding information, for example, about the inventory and the ordering of the parts to the engineering BOM. Hereinafter, unless otherwise stated, a “BOM” refers to a manufacturing BOM.

In contrast, a “BOP (Bills Of Process)” is standard information about manufacturing processes, the information representing the kinds of processes”, “the procedures of the processes”, and the kinds of equipment and tools” used to manufacture an individual product or an individual part included in the product. As illustrated in FIG. 18(c), a production engineer creates a BOP formed by, for example, a “process list” that represents the processes included in an individual process sequence and a “resource list” that represents the resources (equipment, tools, personnel, etc.) included in an individual work area.

As described above, the existing PLM software provides a function of creating and managing a BOM and allowing a plurality of departments to share the related information, for example. However, along with globalization of manufacturing sites and advancement in manufacturing technology, there has been an increasing need for management based on not only a BOM (FIG. 18(b)) and but also a BOP (FIG. 18(c)) including a process list and a resource list in recent years.

By integrally managing a BOP on PLM software, manufacturing-related knowledge (for example, manufacturing knowledge such as a QC process list and work instructions) can be accumulated, shared, and transferred. In this way, the manufacturing knowledge will not be accumulated only individually, and the manufacturing will not be affected by aging or retirement of experienced engineers. In addition, by integrally managing a BOP, standardization of the information about the processes and resources can be facilitated, and the manufacturing process will not be managed only by the manufacturing site(s).

In addition, by integrally managing (namely, by collectively managing) a BOM and a BOP, in the event of a specification change or a malfunction, the affected range including not only parts but also processes and equipment can be determined. Thus, the event can be managed promptly and appropriately. In addition, by integrally managing a BOM and a BOP, product design in view of the equipment and manufacturing process can be encouraged, and sharing equipment enables reduction of fixed costs. In addition, by integrally managing a BOM and a BOP, concurrent engineering on product design and production engineering can be realized. In this way, evaluation results on the productivity can quickly be fed back to the product design. In addition, by creating and registering a BOP on PLM software separately from a BOM, even when a BOM is not created yet, the process design can be started ahead of schedule.

According to the technique described in PTL 1, CAD information including the product- and part-related information and process-related information and a table in which the kinds of processes and parts are associated with each other need to be prepared in advance. According to this technique, the part-related information and the process-related information needs to be designed simultaneously. Namely, the process-related information cannot be designed independently (for example, ahead of schedule) from the part-related information.

Thus, the challenge is to realize integral management of a BOM (a part list) and a BOP (a process list or a resource list) while enabling designing of the BOP independently from designing of the BOM. It is an object of the present invention to provide a process design support apparatus, a process design support method, and a program that contribute to resolving the challenge.

### Solution to Problem

A process design support apparatus according to a first aspect includes: a part list storage part that holds a part list representing a part(s) included in a product; a process list storage part that holds a process list representing a process(es) included in a process sequence(s); and an association part that associates an item(s) included in the part list with an item(s) included in the process list.

A process design support method according to a second aspect includes steps of: causing a computer to hold a part list representing a part(s) included in a product; causing a computer to hold a process list representing a process(es) included in a process sequence(s); and causing a computer to associate an item(s) included in the part list with an item(s) included in the process list.

A program according to a third aspect causes a computer to perform processing for: holding a part list representing a part(s) included in a product; holding a process list representing a process(es) included in a process sequence(s); and associating an item(s) included in the part list with an item(s) included in the process list. This program can be provided as a program product stored in a non-transitory computer-readable storage medium.

### Advantageous Effects of Invention

The process design support apparatus, the process design support method, and the program according to the above aspects can realize integral management of a BOM (a part list) and a BOP (a process list or a resource list) while enabling designing of the BOP independently from designing of the BOM.

### BRIEF DESCRIPTION OF DRAWINGS

FIG. 1 is a block diagram illustrating an example of a configuration of a process design support apparatus according to an exemplary embodiment.

FIG. 2 is a block diagram illustrating an example of a configuration of a process design support apparatus according to a first exemplary embodiment.

FIGS. 3(a) and 3(b) are flowcharts illustrating examples of operations of the process design support apparatus according to the first exemplary embodiment.

FIG. 4 illustrates an example of a manufacturing process of a product.

FIGS. 5(a) to 5(c) illustrate examples of a part list, a production view, and a part list generation procedure, respectively, according to an exemplary embodiment.

FIGS. 6(a) to 6(c) illustrate examples of a process list, a process view, and a process list generation procedure, respectively, according to an exemplary embodiment.

FIGS. 7(a) to 7(c) illustrate examples of a resource list, a resource view, and a resource list generation procedure, respectively, according to an exemplary embodiment.

FIG. 8 illustrates an example of information displayed by the process design support apparatus according to the first exemplary embodiment.

FIG. 9 illustrates an association operation between a product as a dependency source and a process sequence as a dependency destination.

FIG. 10 illustrates an association operation between a process as a dependency source and a part-based configuration as a dependency destination.

FIG. 11 illustrates an association operation between a process as a dependency source and a resource as a dependency destination.

FIG. 12 illustrates an association operation between a part as a dependency source and a resource as a dependency destination.

FIG. 13 illustrates comparative examples 1 and 2.

FIG. 14 is a block diagram illustrating an example of a configuration of a process design support apparatus according to a second exemplary embodiment.

FIG. 15 illustrates an example of information displayed by an impact analysis part in the process design support apparatus according to the second exemplary embodiment.

FIG. 16 is a flowchart illustrating an example of an operation of the process design support apparatus according to the second exemplary embodiment.

FIG. 17 illustrates an impact analysis operation performed by the process design support apparatus according to the second exemplary embodiment.

FIGS. 18(a) to 18(c) illustrate an engineering BOM, a manufacturing BOM, and a BOP, respectively.

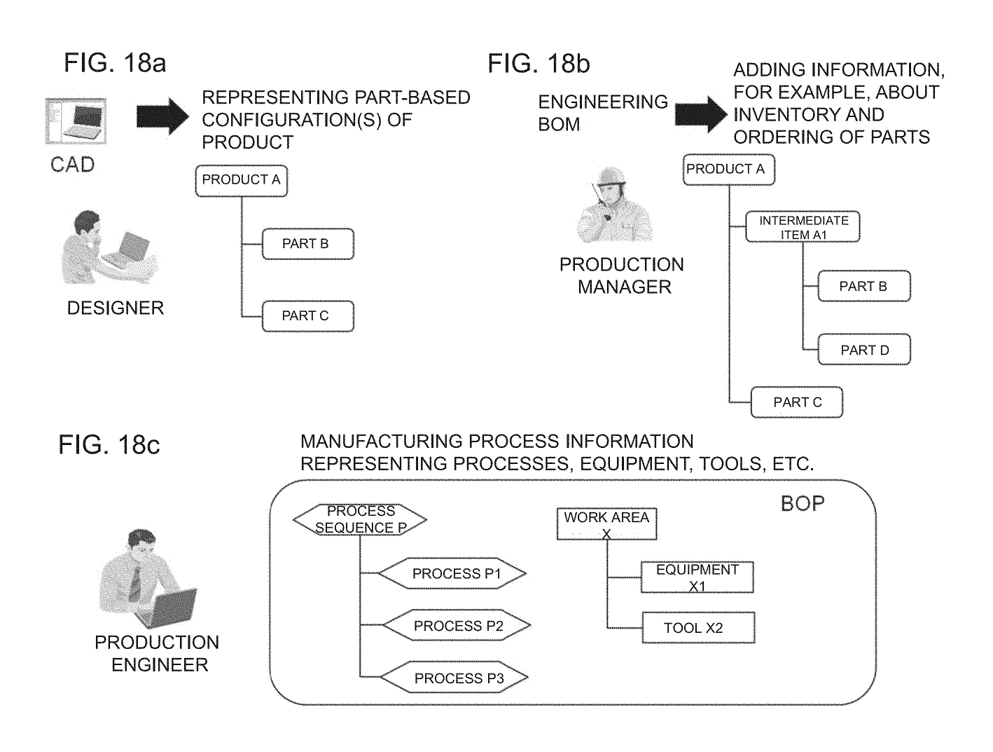

### DESCRIPTION OF EMBODIMENTS

First, an outline of an exemplary embodiment will be described. The reference characters in the following outline are merely used as examples to facilitate understanding of the present invention, not to limit the present invention to the illustrated modes. An individual connection line between blocks in an individual drawing signifies both one-way and two-way directions. An individual arrow schematically illustrates the principal flow of a signal (data) and does not exclude bidirectionality

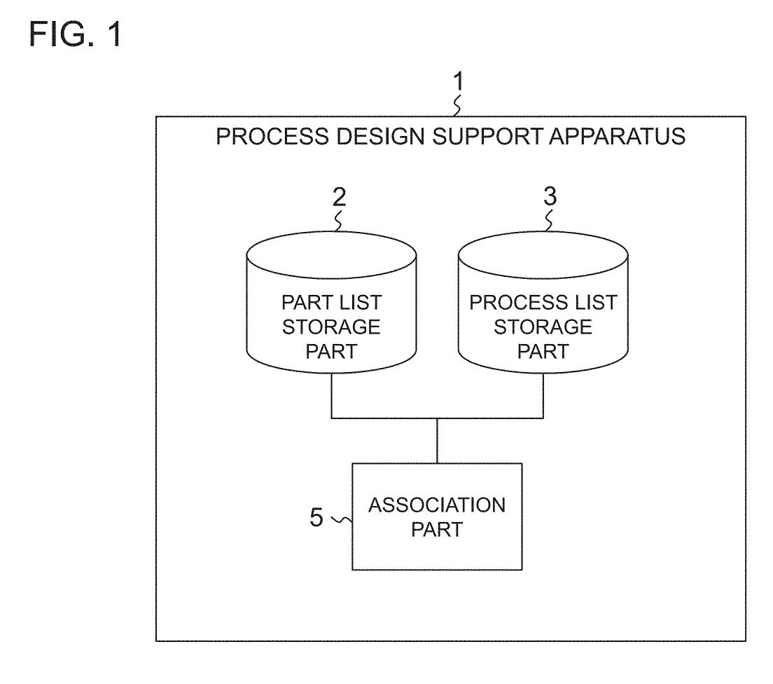

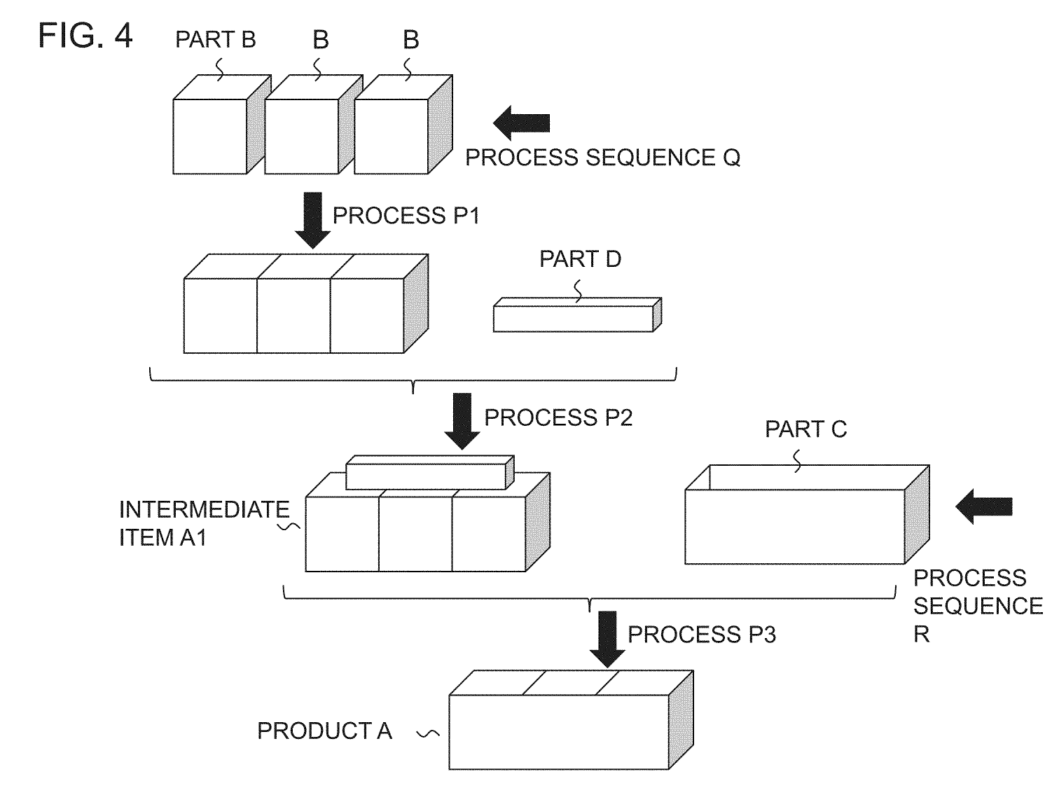

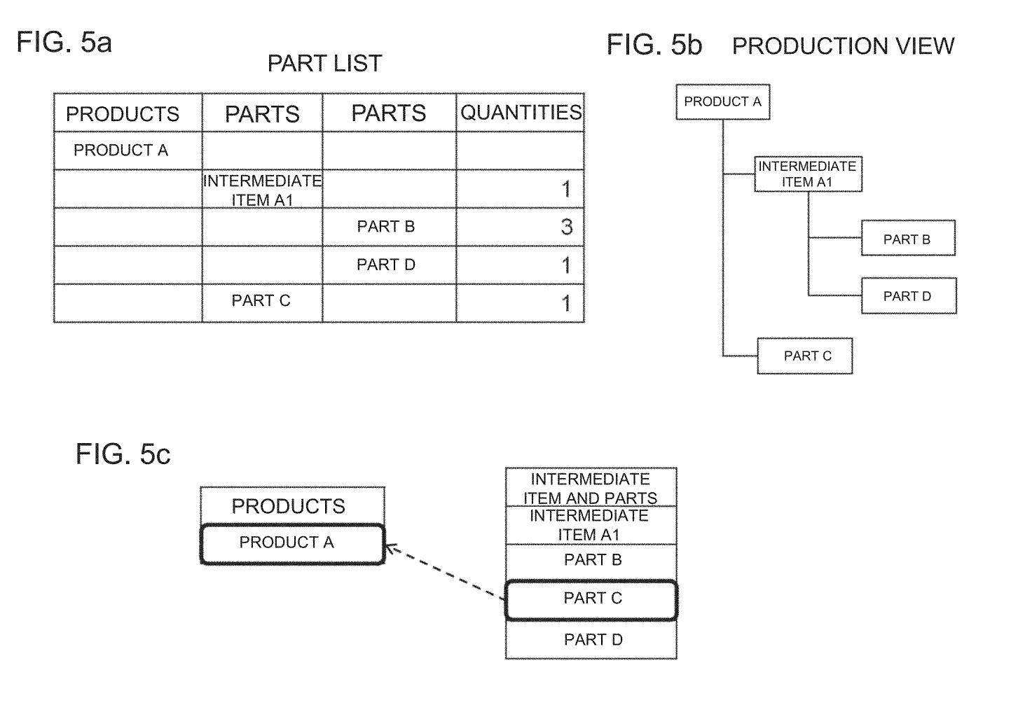

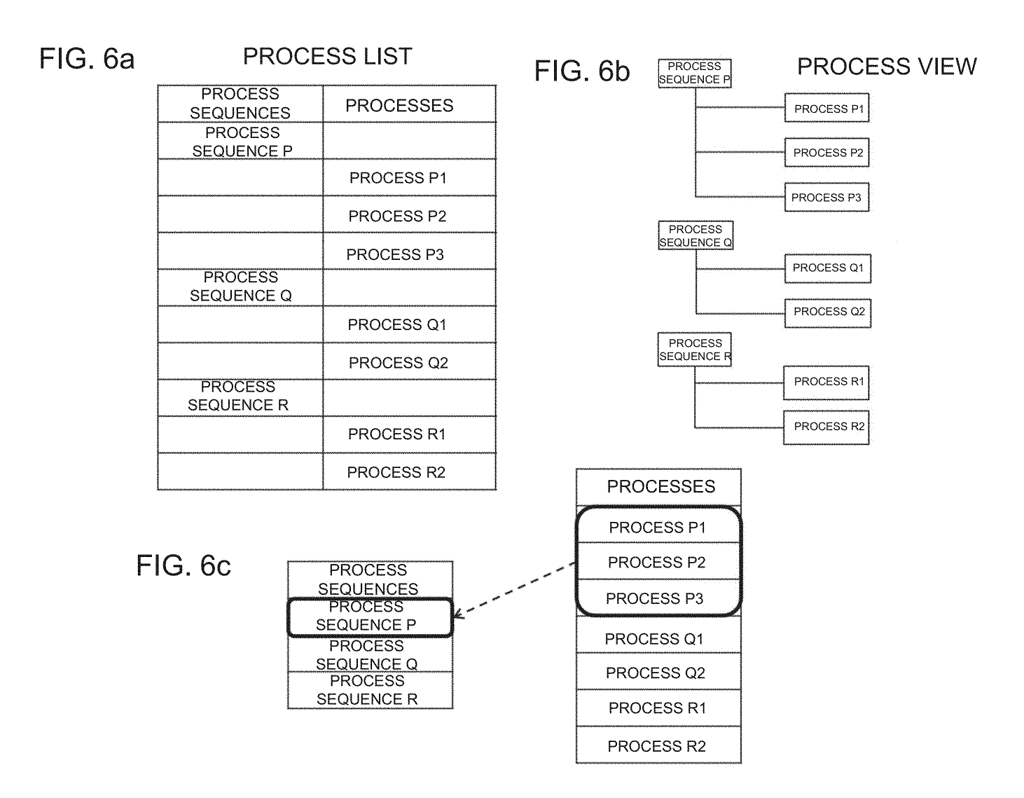

A process design support apparatus according to an exemplary embodiment will be described with reference to drawings. As illustrated in FIG. 1, a process design support apparatus 1 according to an exemplary embodiment includes a part list storage part 2, a process list storage part 3, and an association part 5. The part list storage part 2 holds a part list (for example, FIG. 5(a)) representing a part(s) (for example, parts B and C in FIG. 4) included in a product (for example, a product A in FIG. 4). The process list storage part 3 holds a process list (for example, FIG. 6(a)) representing a process(es) (for example, processes P1 to P3, processes Q1 and Q2, and processes R1 and R2 in FIG. 6) included in a process sequence(s) (for example, process sequences P, Q, and R for manufacturing the product A in FIG. 4). The association part 5 associates an item(s) (for example, the product A) included in the part list with an item(s) (for example, the process sequence P) included in the process list.

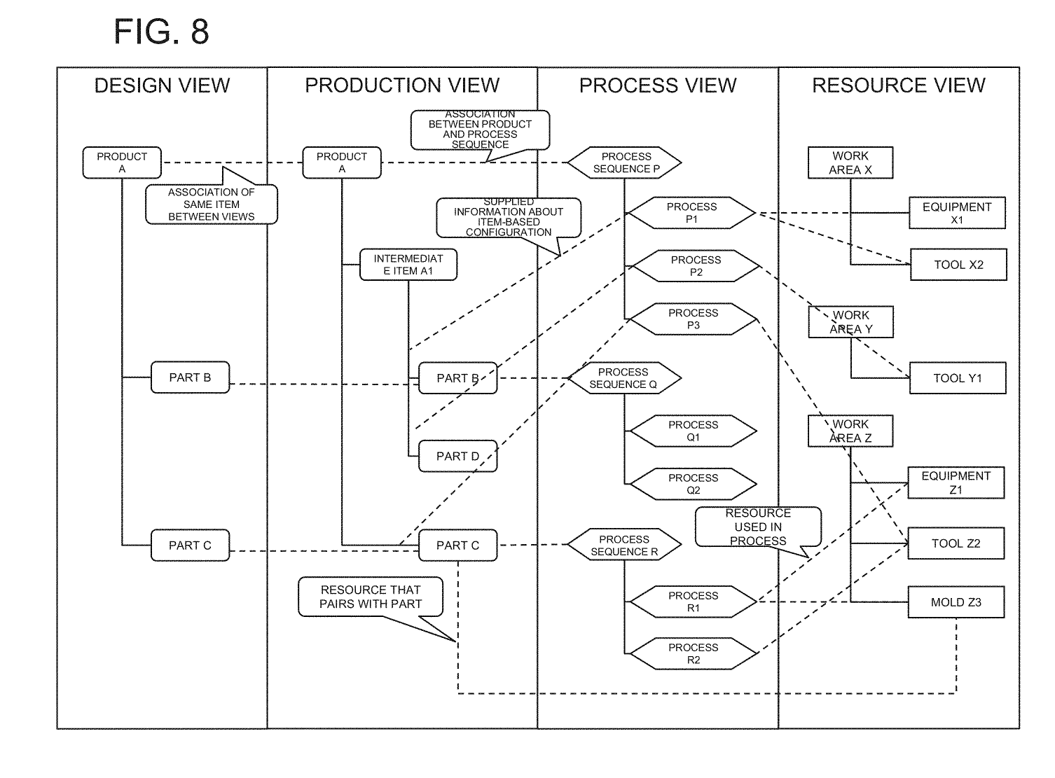

By using the process design support apparatus 1, a BOP (for example, the process list in FIG. 6(a)) can be designed separately from a BOM (for example, the part list in FIG. 5(a)). In addition, a BOM item(s) (or a BOM element(s)) and a BOP item(s), which have been created separately, can be associated with each other (for example, as illustrated in FIG. 8, a product or a part(s) can be associated with a process sequence(s), and a process(es) and a part-based configuration(s) can be associated with each other). Thus, by using the process design support apparatus 1 according to the exemplary embodiment, it is possible to design a BOP independently from a BOM, associate an item(s) included in the BOM with an item(s) included in the BOP, and integrally manage the BOM and the BOP. In addition, by displaying the associations made by the association part 5 of the process design support apparatus 1 as illustrated in FIG. 8, it is possible to easily understand the associations between(among) the product or a part(s) included in the BOM and a process(es) and a resource(s) included in the BOP and the affected range of a design change.

### Exemplary Embodiment 1

Next, a process design support apparatus according to a first exemplary embodiment will be described with reference to drawings.

### [Configuration]

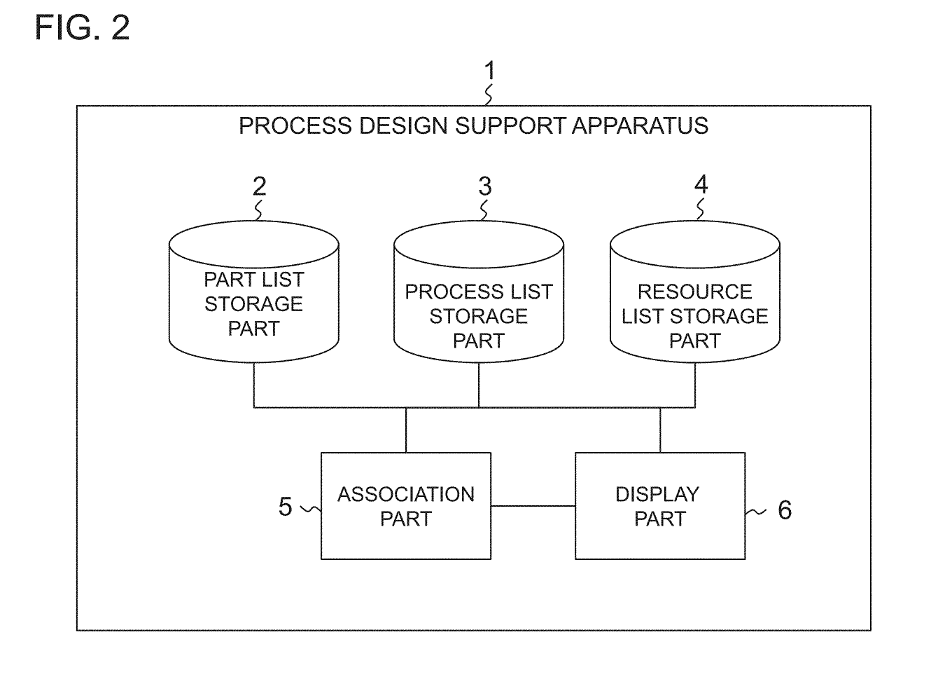

First, a configuration of the process design support apparatus according to the present exemplary embodiment will be described with reference to drawing. As illustrated in FIG. 2, a process design support apparatus 1 according to the present exemplary embodiment includes a part list storage part 2, a process list storage part 3, a resource list storage part 4, an association part 5, and a display part 6.

The part list storage part 2 holds a part list representing a part(s) included in a product. The part list holds the product, the part(s) included in the product, and a part-based configuration(s) of the product based on the part(s) in association with each other. The following example assumes that a product A formed by three parts B and one part C is manufactured via an intermediate item A1 (formed by the parts B and one part D), as illustrated in FIG. 4. In this case, the part list storage part 2 holds the part list illustrated in FIG. 5(a). In this case, the intermediate item is a product obtained halfway through the manufacturing process (the intermediate item is also referred to as an intermediate product or a half-finished product). Namely, the intermediate item is a product that can be held (stored), used, or sold as is for example while not finished yet as an end product. Hereinafter, for simplicity, an intermediate item will be referred to as a “part”. In addition, an individual product and an individual part will collectively be referred to as “an item”. An individual product is identified by information (a product name, a manufacturing number, etc.) that identifies the corresponding product. In addition, an individual part is identified by information (a part name, a manufacturing number, etc.) that identifies the corresponding intermediate item or part. In contrast, a part-based configuration indicates a lower item included in an upper item and the quantity of the lower item (for example, the number of intermediate items A1, parts C, parts D included in the product A, the number of parts B and parts D included in an intermediate item A1, etc.). Other than the number of elements, a different kind of information (weight, volume, length, composition ratio, etc.) may be used as the quantity.

The process list storage part 3 holds a process list representing a process(es) included in a process sequence(es). The process list holds a process sequence(s) and a process(es) included in the process sequence(s) in association with each other. An individual process sequence is identified by information (a process sequence name, a process sequence number, etc.) that identifies the corresponding process sequence. An individual process is identified by information (a process name, a process number, etc.) that identifies the corresponding process. For example, as illustrated in FIG. 4, when the product A is manufactured via the process sequences P, Q, and R and when the process sequences P, Q, and R include the processes P1 to P3, the processes Q1 and Q2, and the processes R1 and R2, respectively, the process list storage part 3 holds the process list illustrated in FIG. 6(a). In this case, an individual process sequence is formed by one process or a plurality of ordered processes. In the example illustrated in FIG. 4, the individual part B is manufactured by the process sequence Q in which the processes Q1 and Q2 are performed sequentially. Likewise, the individual part C is manufactured by the process sequence R in which the processes R1 and R2 are performed sequentially. In addition, the individual product A is manufactured by the process sequence P in which the processes P1 to P3 are performed sequentially.

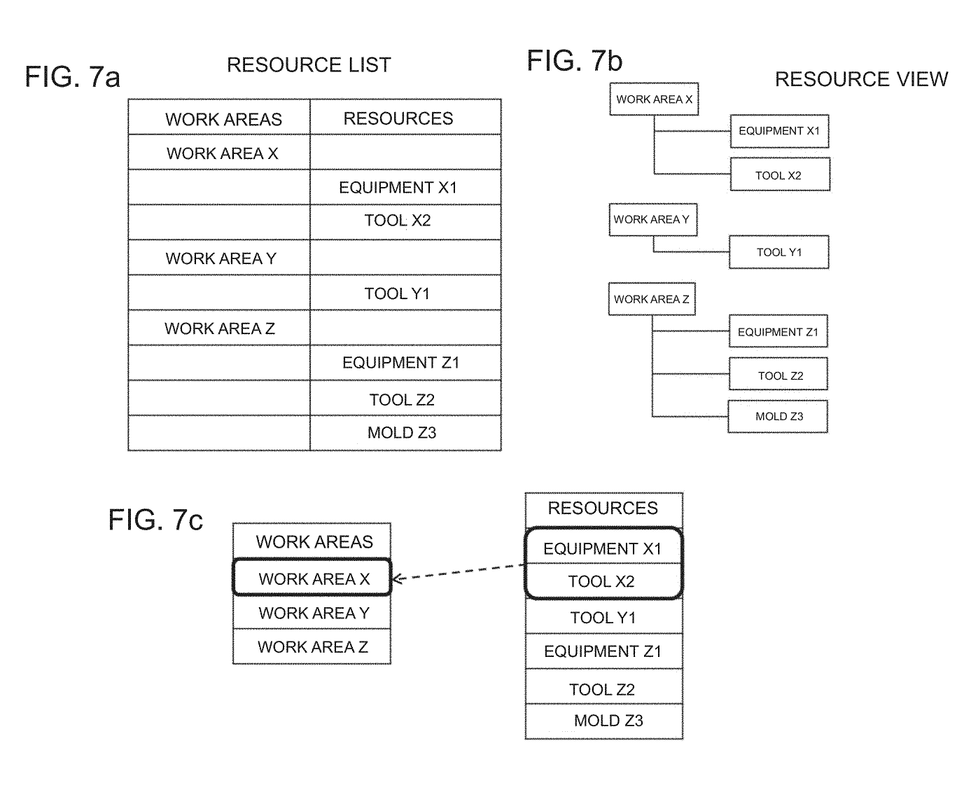

The resource list storage part 4 holds a resource list representing a resource(s) included in a work area(s). The resource list holds a work area(s) and a resource(s) arranged in the work area(s) in association with each other. Herein, a work area is one work section or one of a plurality of work sections at a manufacturing site (a factory, etc.). When a product is manufactured at a plurality of factories, a plurality of work areas may belong to the respective factories. A resource signifies a manufacturing resource included in a work area. Specifically, the resources are equipment, tools (such as jigs), molds, personnel (for example, human resources having certain skills), etc. An individual work area is identified by information (a work area name, a work area number, etc.) that identified the corresponding work area. An individual resource is identified by information (a resource name, a resource number, etc.) that identifies the corresponding resource. When a work area X includes: equipment X1 and a tool X2; a work area Y includes a tool Y1; and a work area Z includes equipment Z1, a tool Z2, a mold Z3, the resource list storage part 4 holds a resource list illustrated in FIG. 7(a).

The association part 5 associates an item(s) included in the part list held by the part list storage part 2, an item(s) included in the process list held by the process list storage part 3, and an item(s) included in the resource list held by the resource list storage part 4 with each other. Among the items included in the part list (for example, FIG. 5(a)), the process list (for example, FIG. 6(a)), and the resource list (for example, FIG. 7(a)), the association part 5 may associate items selected by the user with each other.

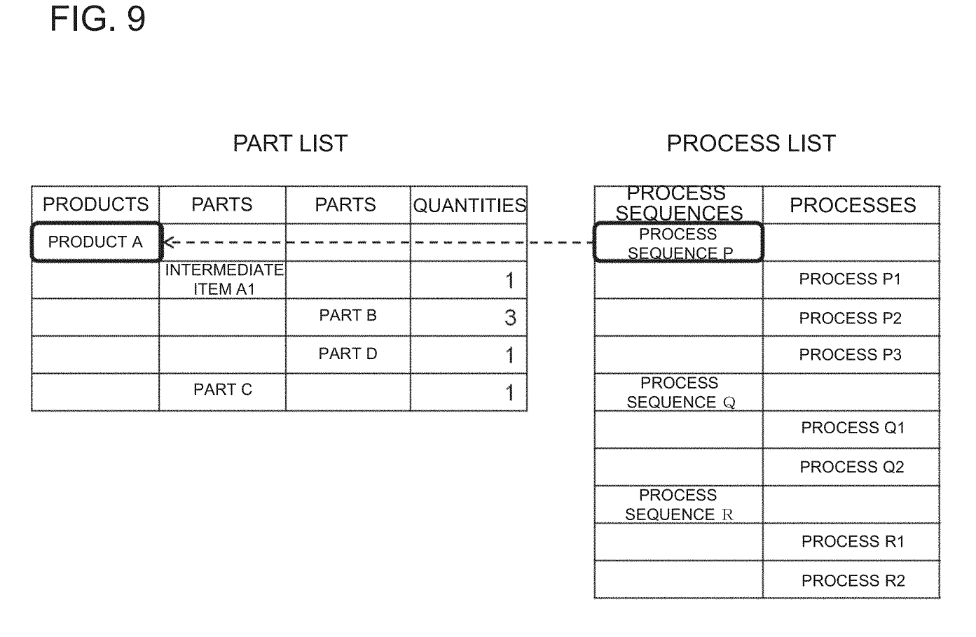

In addition, the user may select a dependency source item(s) and a dependency destination item(s) included in the part list, the process list, and the resource list. In this case, the association part 5 may receive the selected items and set a dependency relationship(s) between(among) the received dependency source item(s) and dependency destination item(s). For example, as illustrated in FIG. 4, when the product A is manufactured by the process sequence P formed by the processes P1 to P3, the product A is dependent on the process sequence P (in this case, the product A is the dependency source, and the process sequence P is the dependency destination). In this case, the association part 5 may set a dependency relationship between the product A (the dependency source) and the process sequence P (the dependency destination) when the association part 5 detects that the user has selected the process sequence P included in the process list and dragged and dropped the select process sequence P to the product A included in the part list (see FIG. 9). With this configuration, the user can easily associate items included in different lists with each other.

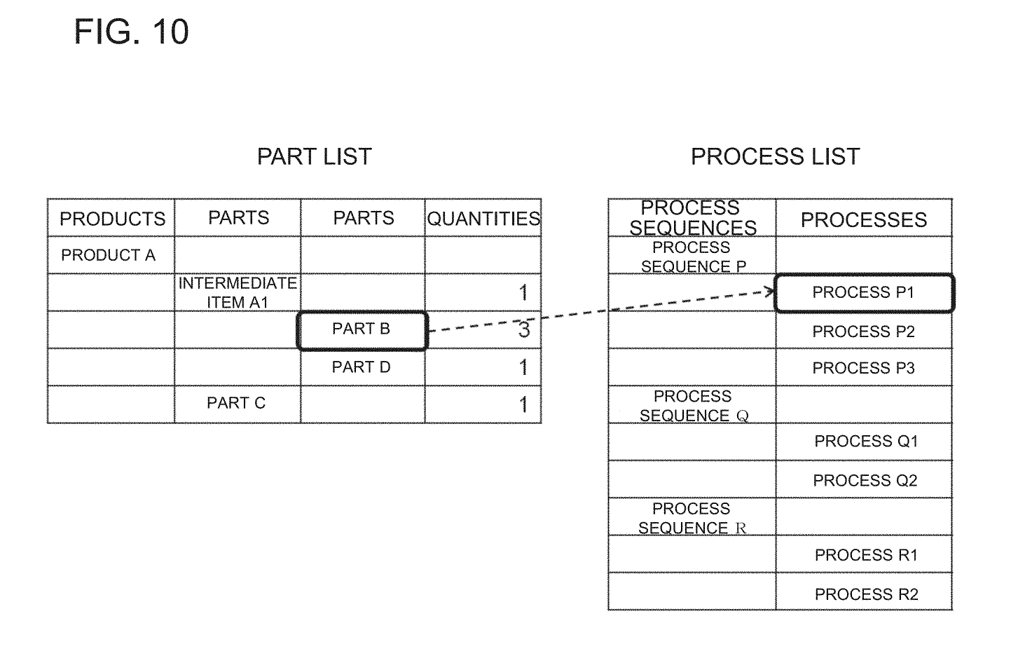

The association part 5 may receive a quantity (also referred to as “supplied information”) of a dependency destination item needed by a dependency source item from the user and associate the received quantity with the dependency relationship between the dependency source item and the dependency destination item. For example, as illustrated in FIG. 4, when execution of the process P1 presupposes completion of manufacturing of three parts B, the process P1 is dependent on the part-based configuration based on the part B (the configuration of the product A based on the part B) (in this case, the process P1 is the dependency source, and the part-based configuration based on the part B is the dependency destination). In this case, the association part 5 sets a dependency relationship between the process P1 (the dependency source) and the part-based configuration based on the part B (the dependency destination) when the association part 5 detects that the user has selected the part-based configuration based on the part B included in the part list and dragged and dropped the selected part-based configuration based on the part B to the process P1 included in the process list (see FIG. 10). The association part 5 may hold the quantity (3, which is the number of parts B in this case) of the part B (the dependency destination item) needed by the process P1 (the dependency source item) in association with the dependency relationship between the process P1 and the part-based configuration based on the part B (as the “supplied information about the item-based configuration”).

The association part 5 can receive various combinations of dependency source items and dependency destination items from the user. For example, the following combinations are possible:

(a) A case in which the association part 5 receives “a product or a part” as a dependency source item and receives “a process sequence” as a dependency destination item (namely, a case in which a predetermined product or part is manufactured by a predetermined process sequence);
(b) A case in which the association part 5 receives “a process” as a dependency source item and receives “a part” as a dependency destination item-based configuration (namely, a case in which execution of a predetermined process presupposes a predetermined quantity of predetermined parts);
(c) A case in which the association part 5 receives “a process” as a dependency source item and receives “a resource” as a dependency destination item (namely, a case in which a predetermined resource is needed when a predetermined process is performed); and
(d) A case in which the association part 5 receives “a product or a part” as a dependency source item and receives “a resource” as a dependency destination item (namely, a case in which a predetermined resource is needed when a predetermined product or part is manufactured).

The individual association that the association part 5 receives from the user is not limited to only one-on-one association. The association part 5 may associate an item with a plurality of items. Alternatively, the association part 5 may associate a plurality of items with other items. For example, the association part 5 may perform the following association when a process P1a is performed by using two parts B and a process P1b is performed by using one part B, instead of performing the process P1 by using three parts B as illustrated in FIG. 4. Namely, the association part 5 may associate the two processes P1a and P1b as the dependency sources with the part-based configuration based on the part B as the dependency destination. In addition, the association part 5 may hold 2, which is the number of parts B, in association with the dependency relationship between the process P1a and the part-based configuration based on the part B and hold 1, which is the number of parts B, in association with the dependency relationship between the process P1b and the part-based configuration based on the part B, as the “supplied information about the item-based configuration”.

When only the association of certain combinations of items is previously set to be allowed, if the user attempts to associate a combination of items other than the set combinations of items, the association part 5 may output an error. For example, when the association part 5 detects an operation in which the user attempts to associate a combination of a dependency source and a dependency destination other than the combinations described in the above (a) to (d), the association part 5 may output an error. In addition, when the user selects an item included in a list, the association part 5 may present an item(s) that can be associated with this item to the user. For example, the association part 5 may display a list(s) including an item(s) that can be associated this item and highlight the item(s) that can be associated in the list(s). With this configuration, even a user(s) who does not have a detailed knowledge of combinable items can appropriately set the association between items.

The display part 6 displays the items included in the part list, the process list, and the resource list in respective trees, for example. For example, the display part 6 hierarchizes the items included in the part list in FIG. 5(a) and displays the hierarchized items in a tree as a production view as illustrated in FIG. 5(b). In addition, the display part 6 hierarchizes the items included in the process list in FIG. 6(b) and displays the hierarchized items in a tree as a process view as illustrated in FIG. 6(b). In addition, the display part 6 hierarchizes the items included in the resource list in FIG. 7(b) and displays the hierarchized items in a tree as a resource view as illustrated in FIG. 7(b). In addition, as illustrated in FIG. 8, the display part 6 connects items, which have been associated with each other by the association part 5, to each other (for example, by a dashed line) and displays the connected items.

### [Operation]

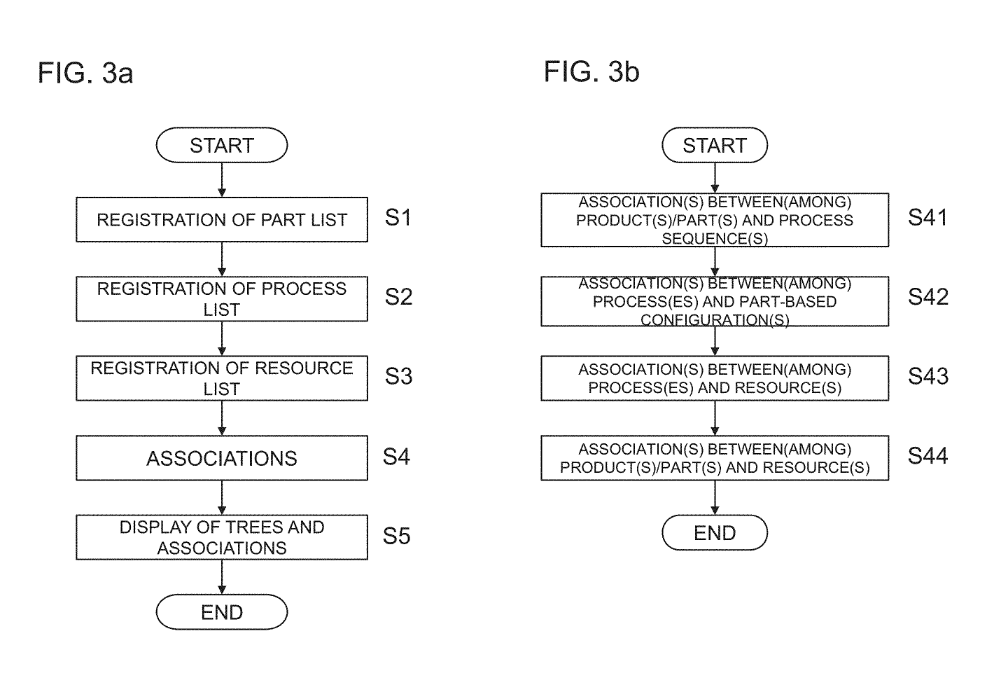

Next, an operation of the process design support apparatus 1 according to the present exemplary embodiment will be described with reference to drawings. FIG. 3(a) is a flowchart illustrating an example of an operation of the process design support apparatus 1 according to the present exemplary embodiment.

Hereinafter, an operation of the process design support apparatus 1 will be described by using the manufacturing process of the product A illustrated in FIG. 4 as an example. As illustrated in FIG. 4, each of the three parts B (for example, members) is manufactured in accordance with the process sequence Q. In contrast, the part C (for example, a container) is manufactured in accordance with the process sequence R, and the product A is manufactured in accordance with the process sequence P including the processes P1 to P3. First, in the process P1, the three parts B are connected to each other. Next, in the process P2, the part D (for example, a handle) is attached to the connected parts B. As a result, the intermediate item A1 is manufactured. Next, in the process P3, the intermediate item A1 is inserted into the part C, and the part D is removed therefrom. As a result, the product A is manufactured.

As illustrated in FIG. 3(a), the part list storage part 2 receives registration of a part list representing a part(s) included in a product(s) from a user (step S1). As illustrated in FIG. 5(c), the part list storage part 2 may receive a product table (the left table in FIG. 5(c)) holding a product (information that identifies a product) and a part table (the right table in FIG. 5(c)) holding an intermediate item(s) or a part(s) (information that identifies an intermediate item(s) or a part(s)) from a user and previously hold these tables. In this case, the part list storage part 2 may generate and hold the part list (see FIG. 5(a)) representing that the product A includes the part C when the part list storage part 2 detects that the user has selected the part C included in the part table and has dragged and dropped the selected part C to the product A included in the product table (see FIG. 5(c)). The part list storage part 2 may receive and hold the quantity (namely, the part-based configuration) based on the part B included in the product A from the user. Herein, the part list storage part 2 holds the part list in FIG. 5(a) based on information inputted by the user. Herein, the product A is formed by the intermediate item A1 and the part C, and the intermediate item A1 is formed by three parts B and one part D. While the part D is included in the intermediate item A1, the part D is not included in the product A as an end product.

Next, the process list storage part 3 receives registration of a process list representing a process(es) included in a process sequence(s) from the user (step S2). As illustrated in FIG. 6(c), the process list storage part 3 may previously receive a process sequence table (the left table in FIG. 6(c)) holding a process sequence(s) (information that identifies a process sequence(s)) and a process table (the right table in FIG. 6(c)) holding a process(es) (information that identifies a process(es)) from the user and hold these tables. In this case, the process list storage part 3 may automatically generate and hold the process list (see FIG. 6(a)) indicating that the process sequence P includes the processes P1 to P3 when the process list storage part 3 detects that the user has selected the processes P1 to P3 included in the process table and dragged and dropped the selected processes P1 to P3 to the process sequence P included in the process sequence table (see FIG. 6(c)). Herein, the process list storage part 3 holds the process list in FIG. 6(a) based on information inputted by the user. As illustrated in FIG. 4, the individual part B is manufactured by the process sequence Q including the processes Q1 and Q2, and the part C is manufactured by the process sequence R including the processes R1 and R2. In addition, the product A is manufactured by the process sequence P including the processes P1 to P3.

Next, the resource list storage part 4 receives registration of a resource list representing a resource(s) included in a work area(s) from the user (step S3). As illustrated in FIG. 7(c), the resource list storage part 4 may receive a work area table (the left table in FIG. 7(c)) holding a work area(s) (information that identifies a work area(s)) and a resource table (the right table in FIG. 7(c)) holding a resource(s) (information that identifies a resource(s)) from the user and previously hold these tables. In this case, the resource list storage part 4 may generate and hold a resource list (see FIG. 7(a)) indicating that the work area X includes the equipment X1 and the tool X2 as the resources when the resource list storage part 4 detects that the user has selected the resources (the equipment X1 and the tool X2) included in the resource table and dragged and dropped the selected resources (X1 and X2) to the work area X included in the work area table (see FIG. 7(c)). Herein, the resource list storage part 4 holds the resource list in FIG. 7(a) based on information inputted by the user. As illustrated in FIG. 7(a), the work area X includes the equipment X1 and the tool X2, the work area Y includes the tool Y1, and the work area Z includes the equipment Z1, the tool Z2, and the mold Z3.

The registration order of the part list, the process list, and the resource list in steps S1 to S3 in FIG. 3(a) is not limited to any particular order.

Next, the association part 5 associates an item(s) included in the part list (FIG. 5(a)) held by the part list storage part 2, an item(s) included in the process list (FIG. 6(a)) held by the process list storage part 3, and an item(s) included in the resource list (FIG. 7(a)) held by the resource list storage part 4 with each other in accordance with selection by the user (step S4). The association operation in step S4 will be described below with reference to FIG. 3(b).

Next, the display part 6 displays the items included in the part list (FIG. 5(a)), the process list (FIG. 6(a)), and the resource list (FIG. 7(a)) in respective trees, as a production view, a process view, and a resource view illustrated in FIG. 8 (step S5). In addition, as illustrated in FIG. 8, the display part 6 connects items, which have been associated with each other by the association part 5, to each other (for example, by a dashed line) and displays the connected items (step S5).

Next, detailed operations of the “association” in step S4 in FIG. 3(a) will be described.

As illustrated in FIG. 3(b), when a predetermined product or part is manufactured by a predetermined process sequence, the association part 5 associates the product/part (the dependency source) with the process sequence (the dependency destination) based on an operation by the user (step S41). Herein, as illustrated in FIG. 4, the product A is manufactured by the process sequence P including the processes P1 to P3. As illustrated in FIG. 9, the user selects the process sequence P included in the process list and drags and drops the selected process sequence P to the product A included in the part list. When the association part 5 detects this operation by the user, the association part 5 determines that the product A is dependent on the process sequence P and sets a dependency relationship between the product A (the dependency source) and the process sequence P (the dependency destination). Likewise, based on an operation by the user, the association part 5 associates the part B (the dependency source) and the process sequence Q (the dependency destination) and associates the part C (the dependency source) with the process sequence R (the dependency destination).

Next, when execution of a predetermined process(es) presupposes a predetermined quantity(ies) of a predetermined part(s), based on an operation by the user, the association part 5 associates the process(es) (the dependency source(s)) with the part-based configuration(s) (the dependency destination(s)) (step S42). Herein, as illustrated in FIG. 4, execution of the process P1 presupposes completion of manufacturing of three parts B. As illustrated in FIG. 10, the user selects the part B included in the part list and drags and drops the selected part B to the process P1 included in the process list (see FIG. 10). When the association part 5 detects this operation by the user, the association part 5 determines that the process P1 is dependent on the part-based configuration based on the part B and sets a dependency relationship between the process P1 (the dependency source) and the part-based configuration based on the part B (the dependency destination). The association part 5 may hold the quantity (3 as the number of parts B) of the part-based configuration (the dependency destination item) based on the part B needed by the process P1 (the dependency source item) in association with the dependency relationship between the process P1 and the part-based configuration based on the part B (as the “supplied information about the item-based configuration”). Likewise, based on an operation by the user, the association part 5 associates the process P2 (the dependency source) with the part-based configuration (the dependency destination) based on the part D and associates the process P3 (the dependency source) with the part-based configuration (the dependency destination) based on the part C.

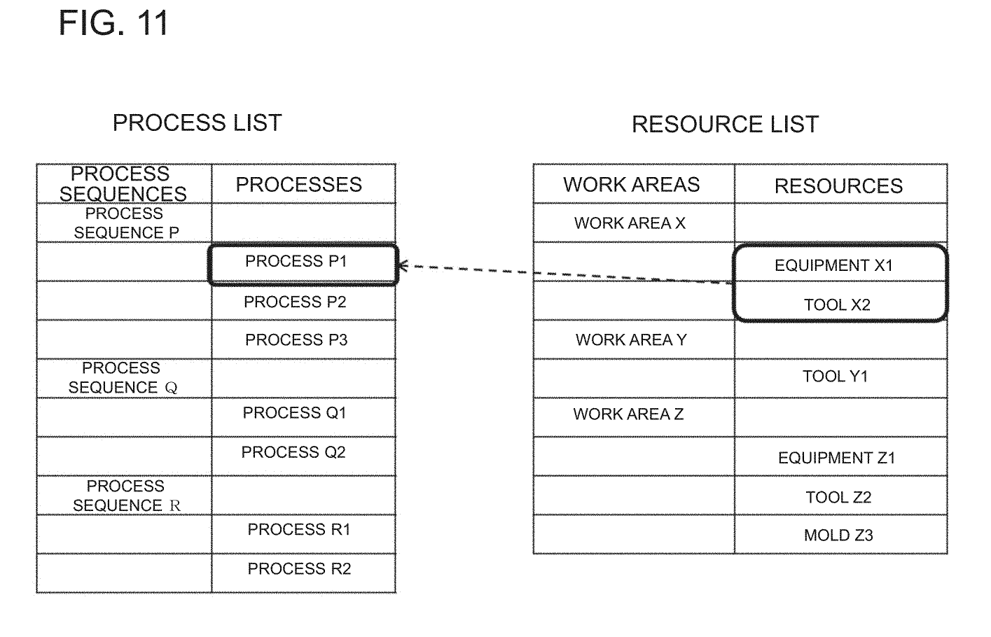

Next, when execution of a predetermined process(es) presupposes use of a predetermined resource(s), based on an operation by the user, the association part 5 associates the process(es) (the dependency source(s)) with the resource(s) (the dependency destination(s)) (step S43). Herein, when the process P1 is performed, the equipment X1 and the tool X2 in the work area X are used. As illustrated in FIG. 11, the user selects the equipment X1 and the tool X2 included in the resource list and drags and drops the selected resources to the process P1 included in the process list (see FIG. 11). When the association part 5 detects this operation by the user, the association part 5 determines that the process P1 is dependent on these resources, namely, the equipment X1 and the tool X2, and sets a dependency relationship between the process P1 (the dependency source) and “the equipment X1 and the tool X2” (the dependency destinations). Likewise, based on an operation by the user, the association part 5 associates the process P2 (the dependency source) with the tool Y1 (the dependency destination), associates the process P3 (the dependency source) with the tool Z2 (the dependency destination), associates the process R1 (the dependency source) with “the equipment Z1 and the mold Z3” (the dependency destinations), and associates the process R2 (the dependency source) with the tool Z2 (the dependency destination).

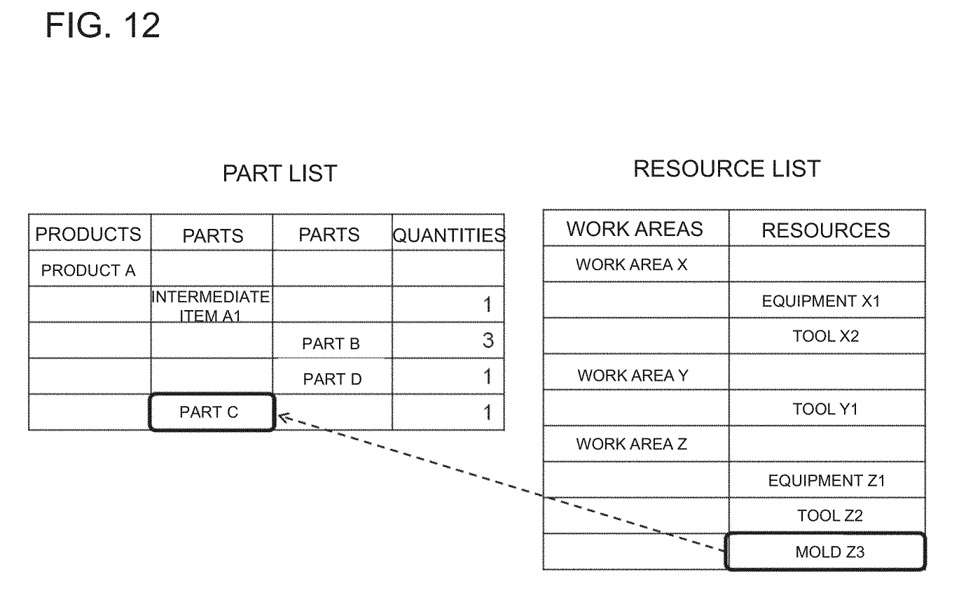

Next, when manufacturing a predetermined product(s) or part(s) needs a predetermined resource(s), based on an operation by the user, the association part 5 associates the product/part(s) (the dependency source(s)) with the resource(s) (the dependency destination(s)) (step S44). Herein, manufacturing the part C presupposes the dedicated mold Z3 included in the work area Z. As illustrated in FIG. 12, the user selects the mold Z3 included in the resource list and drags and drops the selected resource to the part C included in the part list (see FIG. 12). When the association part 5 detects this operation by the user, the association part 5 determines that the part C is dependent on this resource, namely, the mold Z3, and sets a dependency relationship between the part C (the dependency source) and the mold Z3 (the dependency destination).

The order of steps S41 to S44 in FIG. 3 is not limited to any particular order. In addition, the associations performed by the association part 5 is not limited to the four kinds of association in steps S41 to S44. Namely, other items may be associated with each other.

FIG. 8 illustrates an example of information displayed by the display part 6. The display part 6 displays an individual association among a product or a part, a process sequence or a process, and a resource made by the association part 5 by using a dashed line. The use can understand, for example, that the product A is manufactured by the process sequence P and that the parts B and C are manufactured by the process sequences Q and R, respectively, by viewing FIG. 8. In addition, the display part 6 displays an individual association between a process and a part-based configuration made by the association part 5 by using a dashed line. The user can understand, for example, that execution of the processes P1 to P3 presupposes existence (completion) of manufacturing of the parts B, D, and C, respectively, by viewing FIG. 8. In addition, the display part 6 displays an individual association between a process and a resource made by the association part 5 by using a dashed line. The user can understand, for example, that the process P1 is performed by using the equipment X1 and the tool X2, the process P2 is performed by using the tool Y1, and the process P3 is performed by using the tool Z2 by viewing FIG. 8. In addition, the user can understand that the process R1 is performed by using the equipment Z1 and the mold Z3 and that the process R2 is performed by using the tool Z2. In addition, the display part 6 displays an individual association between a product or a part and a resource made by the association part 5 by using a dashed line. The user can understand, for example, that the part C is manufactured by using the mold Z3 by viewing FIG. 8.

### Advantageous Effects

After the process design support apparatus 1 according to the present exemplary embodiment receives registration of a BOM (for example, the part list in FIG. 5(a)) and a BOP (for example, the process list in FIG. 6(a) or the resource list in FIG. 7(a)) from the user, the process design support apparatus 1 receives an association between an item included in the BOM and an item included in the BOP from the user and displays the received association (for example, FIG. 8). With this configuration, the user can design a BOP (a process list, a resource list, etc.) independently from a BOM (a part list). In addition, even when a BOM is not completed in advance, the user can start to design a process list or a resource list ahead of schedule. In addition, with the process design support apparatus 1, an item(s) included in a BOM and an item(s) included in a BOP can be associated with each other and integrally managed. Thus, according to the present exemplary embodiment, it is possible to realize integral management of a BOM (a part list) and a BOP (a process list or a resource list) while enabling designing of the BOP independently from the BOM.

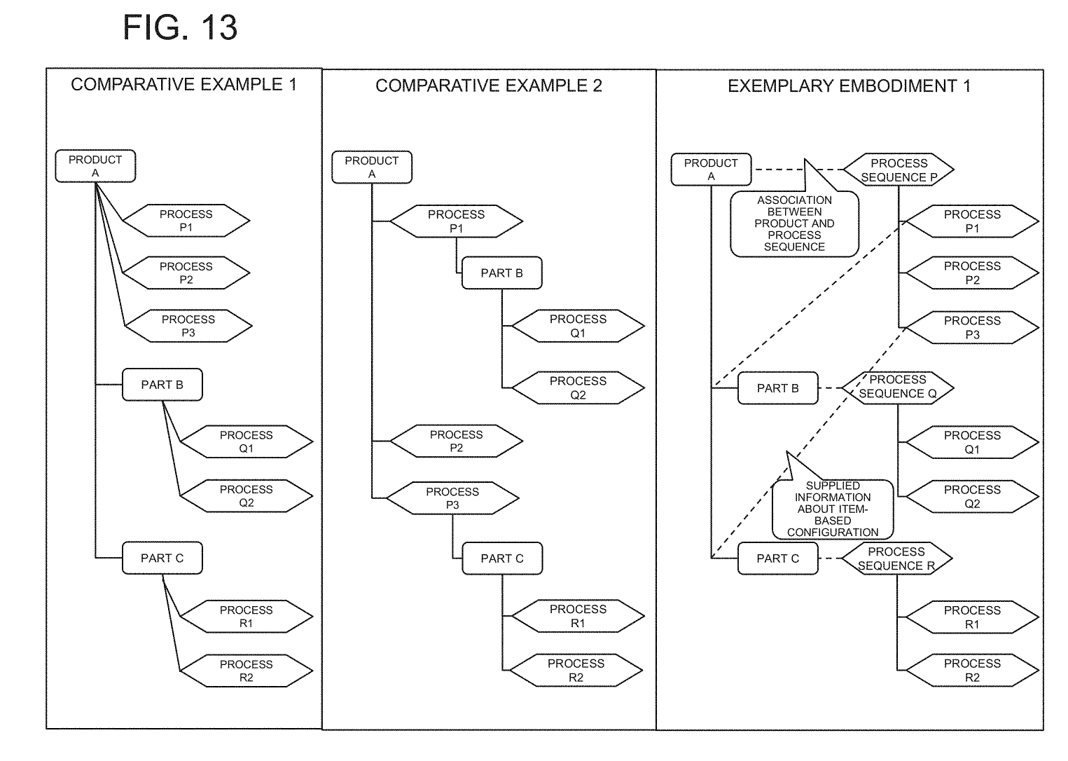

Next, advantageous effects of the process design support apparatus 1 according to the present exemplary embodiment will be described in more detail by comparing the present exemplary embodiment with comparative examples. FIG. 13 illustrates the comparison between the present exemplary embodiment and comparative examples 1 and 2.

In comparative examples 1 and 2 illustrated on the left side and in the middle in FIG. 13, the methods for manufacturing the product and the parts (the processes and the resources such as the equipment based on the specifications) are managed as information added to the product and parts in a part list. Comparative examples 1 and 2 are advantageous in that the user can easily understand the association between the product or a part and a process. However, according to comparative examples 1 and 2, it is difficult to manage the BOP independently from the BOM (the part list). Namely, it is difficult to design the process list or the resource list ahead of schedule, irrespective of the presence or absence of a part list. In addition, according to comparative examples 1 and 2, since the processes are incorporated in the part list, it is difficult to use the process list or the resource list for the part list of another product. In addition, according to comparative examples 1 and 2, it is difficult to associate a plurality of process sequences with a single product (the part list of a single product).

In contrast, according to the present exemplary embodiment, after a BOM (a part list) and a BOP (a process list and a resource list) are separately designed and a hierarchical relationship (a parent-child relationship) is established for each of the part list, the process list, and the resource list, items included in these lists are associated with each other (see FIG. 8 and the right side in FIG. 13). With this configuration, the BOP can be integrally managed independently from the BOM. Thus, standardization of the manufacturing process can be achieved, and the process list or the resource list can easily be used for another product (the part list of another product). In addition, by managing the BOP independently from the part list (BOM), even when the part list is not completed yet, the process list or the resource list can be designed ahead of schedule. In addition, according to the present exemplary embodiment, since the process list and the resource list are managed separately from the part list, a plurality of items in the process list or a plurality of items in the part list can be associated with a certain product (the part list of a certain product). Thus, it is possible to easily manage the line difference (internal manufacturing that uses a plurality of manufacturing lines) and internal and external manufacturing (a combination of internal manufacturing and outsourcing).

### Exemplary Embodiment 2

Next, a process design support apparatus according to a second exemplary embodiment will be described with reference to drawings.

### [Configuration]

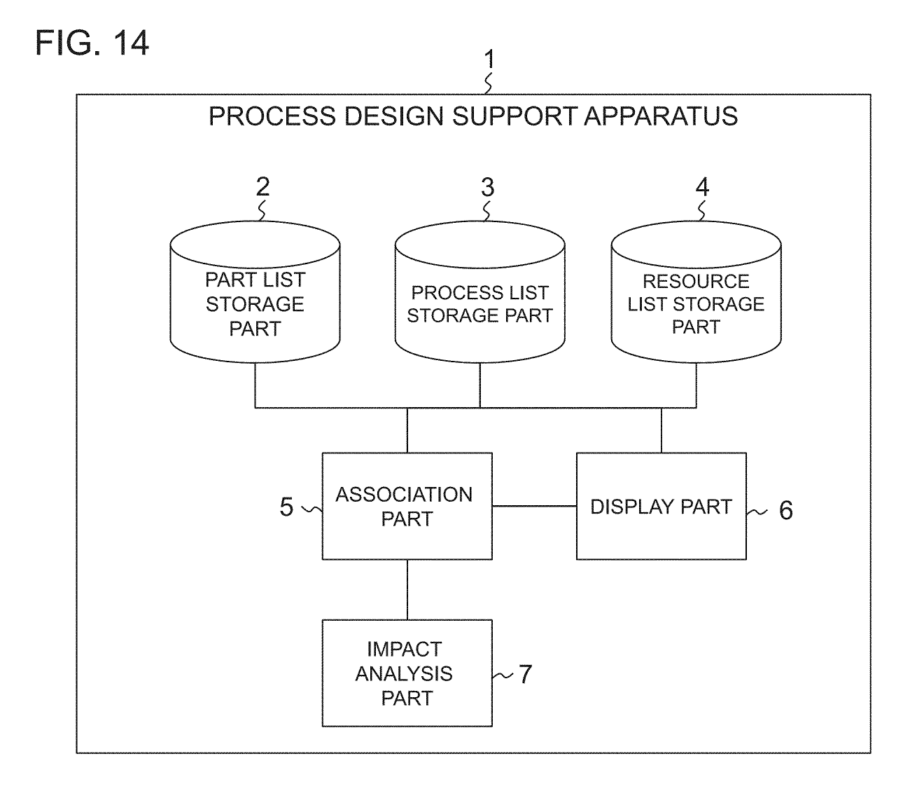

FIG. 14 is a block diagram illustrating an example of a configuration of a process design support apparatus according to the present exemplary embodiment. As illustrated in FIG. 14, a process design support apparatus 1 according to the present exemplary embodiment includes a part list storage part 2, a process list storage part 3, a resource list storage part 4, an association part 5, a display part 6, and an impact analysis part 7. Namely, the process design support apparatus 1 according to the present exemplary embodiment includes the impact analysis part 7 in addition to the elements of the process design support apparatus 1 according to the first exemplary embodiment (FIG. 2).

When a certain item included in the part list, the process list, or the resource list is changed, the impact analysis part 7 extracts a different item(s) affected by this change based on the associations by the association part 5. As described in the first exemplary embodiment, the association part 5 holds items selected by the user among the items included in the part list (for example, FIG. 5(a)), the process list (for example, FIG. 6(a)), and the resource list (for example, FIG. 7(a)) in association with each other. For example, as illustrated in FIG. 11, when the process P1 is associated with the equipment X1 and the tool X2 by the association part 5, if the tool X2 malfunctions, the impact analysis part 7 extracts the process P1 based on the corresponding association. In contrast, as illustrated in FIG. 12, when the part C is associated with the mold Z3 by the association part 5, if a design change is made to the part C, the impact analysis part 7 extracts the mold Z3 based on the corresponding association.

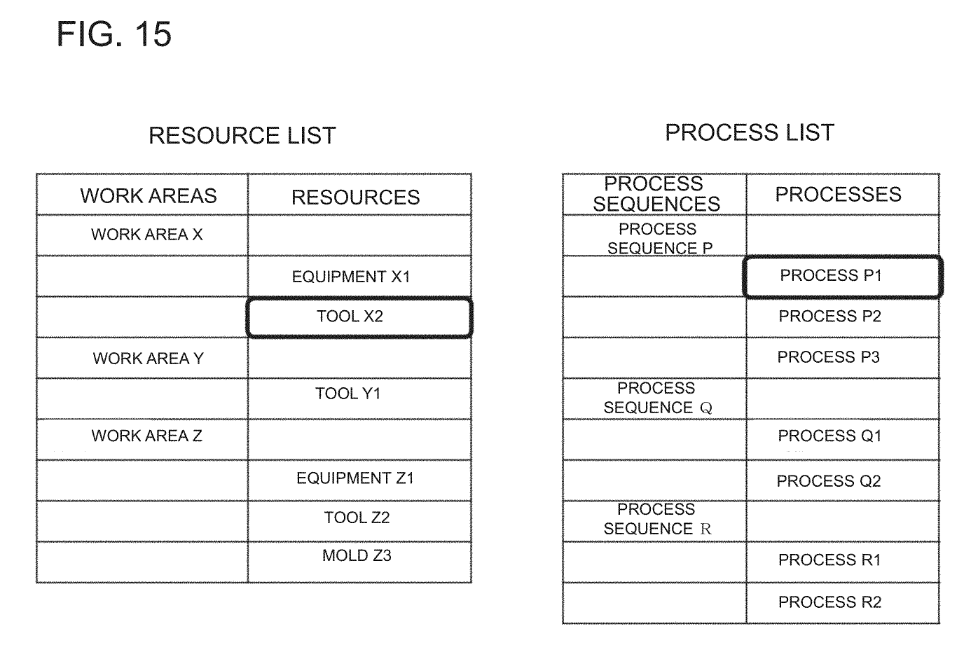

The impact analysis part 7 may extract not only items directly associated by the association part 5 but also items indirectly associated by the association part 5. In addition, the impact analysis part 7 may display a list of extracted items. The impact analysis part 7 may display a list including an item to which a change has been made (a design change, a malfunction, or the like) and a list including an item(s) directly affected by the change side by side. In this case, the impact analysis part 7 may highlight the changed item and the affected item(s). For example, when the process P1 is associated with the equipment X1 and the tool X2 by the association part 5, if the tool X2 malfunctions, as illustrated in FIG. 15, the impact analysis part 7 may display the resource list and the process list and highlight the tool X2 and the process P1 in these lists.

### [Operation]

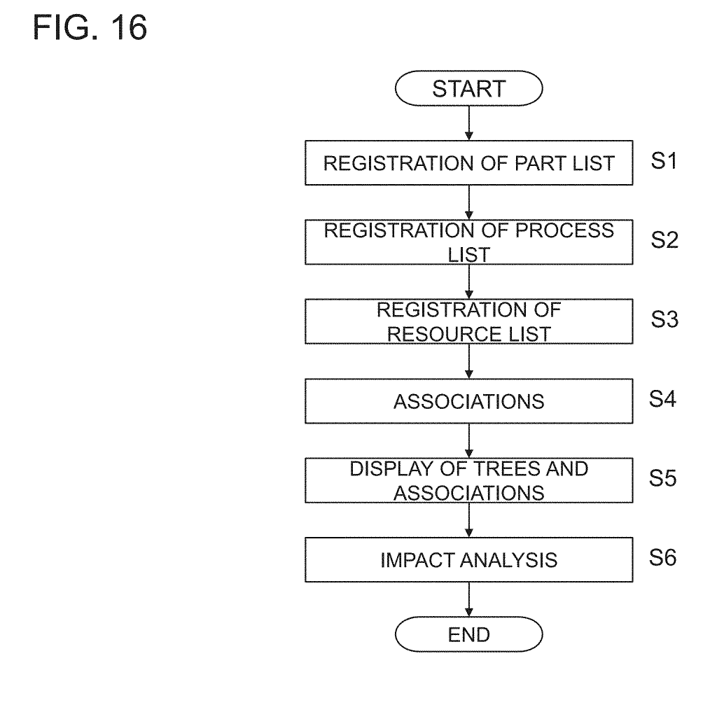

Next, an operation of the process design support apparatus 1 according to the present exemplary embodiment will be described with reference to drawings. FIG. 16 is a flowchart illustrating an example of an operation of the process design support apparatus 1 according to the present exemplary embodiment.

Hereinafter, an operation of the process design support apparatus 1 will be described by using the manufacturing process of the product A illustrated in FIG. 4 as an example. The operations in steps S1 to S5 in FIG. 16 are the same as the operations in steps S1 to S5 in FIG. 3(a) according to the first exemplary embodiment. The following description assumes that the associations as indicated by the dashed lines in FIG. 8 have already been made by the registration operations (steps S1 to S3) of the part list (FIG. 5(a)), the process list (FIG. 6(a)), and the resource list (FIG. 7(a)) and the association operations (see step S4 and FIGS. 9 to 12) performed by the association part 5.

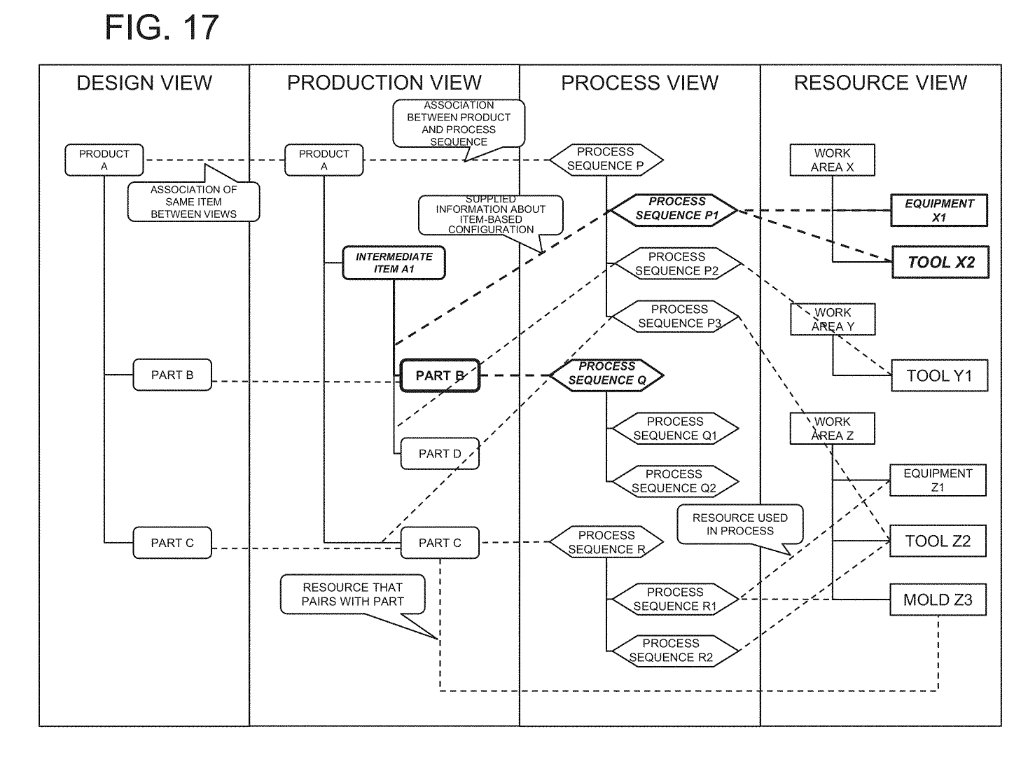

In this case, when a design change is made to the part B and when the impact analysis part 7 receives the change of the part B from the user, the impact analysis part 7 refers to the associations made by the association part 5 (in this case, the associations indicated by the dashed lines in FIG. 8) and determines the other items affected by the change. As illustrated in FIG. 8, when a design change is made to the part B, the intermediate item A1, the process P1, the equipment X1, the tool X2, the process sequence Q, etc. could be affected directly or indirectly. Thus, the impact analysis part 7 presents the intermediate item A1, the process P1, the equipment X1, the tool X2, and the process sequence Q to the user. In addition, the impact analysis part 7 may instruct the display part 6 to highlight the items affected (directly or indirectly) by the design change on the part B (for example, change the display mode by using a color, a font, or the like), as illustrated in FIG. 17. In addition, the impact analysis part 7 may notify a manager or a person in charge of the affected items (for example, the resources) of the design change.

### Advantageous Effects

The process design support apparatus 1 according to the present exemplary embodiment provides the same advantageous effects as those provided by the process design support apparatus 1 according to the first exemplary embodiment. In addition, according to the present exemplary embodiment, when a design change or a malfunction occurs, the impact analysis part 7 can determine not only the corresponding part but also a process(es), equipment, etc. that are affected. Thus, when a new product is brought to market or a malfunction occurs, it is possible to quickly perform tracing including the parts, the processes, and the resources and respond to customer requests.

### <Variations>

In the BOM (for example, the part list illustrated in FIG. 5(a)) and the BOP (for example, the process list illustrated in FIG. 6(a) or the resource list illustrated in FIG. 7(a)) according to the above exemplary embodiments, the versions of the product, the parts, the process sequences, the processes, the work areas, and the resources may be registered. In this case, when the association part 5 associates an item(s) included in the part list held by the part list storage part 2, an item(s) included in the process list held by the process list storage part 3, and an item(s) included in the resource list held by the resource list storage part 4 with each other, the association part 5 may associate items of the same version with each other. The association part 5 may associate items of different versions with each other. The association part 5 may associate items of any version without distinguishing the versions. The association part 5 may associate items of a certain version or a plurality of versions.

As described above, in addition to the above information, by registering a version(s) in a BOM (a part list) and a BOP (a process list or a resource list), even when a design change is made to a part or a process, the BOMs and the BOPs before and after the change can be integrally managed. In addition, with this configuration, since the association part 5 associates a product with the process sequences and the resources of both old and new versions, for example, when a single kind of product is manufactured in large numbers, some products can be manufactured by using a process sequence(s) and a resource(s) of the old version, and the other products can be manufactured by using a process sequence(s) and a resource(s) of the new version. Likewise, since the association part 5 associates products of the old and new versions with a process sequence(s) or a resource(s) of a certain version, the products of the old and new versions can be manufactured by using the same process sequence(s) and resource(s).

According to the present invention, the following modes are possible.

### [Mode 1]

See the process design support apparatus according to the above first aspect.

### [Mode 2]

The process design support apparatus according to mode 1; wherein the association part associates items selected by a user with each other, at least one of the items being included in the part list and at least another one of the items being included in the process list.

### [Mode 3]

The process design support apparatus according to mode 2; wherein the association part receives a dependency source item(s) included in one of the part list and the process list and a dependency destination item(s) included in the other one of the lists from a user and sets a dependency relationship between(among) the received items.

### [Mode 4]

The process design support apparatus according to mode 3; wherein, when a combination of a dependency source item(s) and a dependency destination item(s) received from a user is a predetermined combination, the association part sets a dependency relationship between(among) the received items.

### [Mode 5]

The process design support apparatus according to mode 3 or 4; wherein, when the user drags and drops a first item included in a first list, which corresponds to the part list or the process list, to a second item included in a second list, the association part sets one of the first item and the second item as a dependency source item and the other item as a dependency destination item.

### [Mode 6]

The process design support apparatus according to any one of modes 3 to 5; wherein the association part receives a quantity(ies) of the dependency destination item(s) needed by the dependency source item(s) from a user and associates the received quantity(ies) with the dependency relationship(s) set between(among) the dependency source item(s) and the dependency destination item(s).

### [Mode 7]

The process design support apparatus according to any one of modes 1 to 6;

wherein the part list holds a product, a part(s) included in the product, and a part-based configuration(s) of the product based on the part(s) in association with each other; and/or

wherein the process list holds a process sequence(s) and a process(es) included in the process sequence(s) in association with each other.

### [Mode 8]

The process design support apparatus according to mode 7; wherein the association part receives, as an associable combination of a dependency source item and a dependency destination item, at least one of: a combination of a product or a part included in the part list and a process sequence included in the process list; and a combination of a process included in the process list and a part-based configuration included in the part list, from a user.

### [Mode 9]

The process design support apparatus according to any one of modes 1 to 8, comprising an impact analysis part that extracts, when a change is made to an item included in the part list or the process list, a different item(s) affected by the change, based on the association by the association part.

### [Mode 10]

The process design support apparatus according to any one of modes 1 to 9, comprising a display part that displays the items included in the part list and the items included in the process list in respective trees and displays the items associated by the association part with each other by connecting the items to each other.

### [Mode 11]

The process design support apparatus according to mode 1, comprising:

a resource list storage part that holds a resource list representing a resource(s) included in a work area(s);

wherein the association part associates an item(s) included in the part list or the process list with an item(s) included in the resource list.

### [Mode 12]

The process design support apparatus according to mode 11; wherein the association part associates items selected by a user with each other, the items being included in different lists among the part list, the process list, and the resource list.

### [Mode 13]

The process design support apparatus according to mode 12; wherein the association part receives a dependency source item(s) and a dependency destination item(s) included in different lists among the part list, the process list, and the resource list from a user and sets a dependency relationship between(among) the received items.

### [Mode 14]

The process design support apparatus according to mode 13; wherein, when a combination of a dependency source item(s) and a dependency destination item(s) received from a user is a predetermined combination, the association part sets a dependency relationship between(among) the received items.

### [Mode 15]

The process design support apparatus according to mode 13 or 14; wherein, when the user drags and drops a first item included in a first list, which corresponds to the part list, the process list, or the resource list, to a second item included in a second list, the association part sets one of the first item and the second item as a dependency source item and the other item as a dependency destination item.

### [Mode 16]

The process design support apparatus according to any one of modes 13 to 15; wherein the association part receives a quantity(ies) of the dependency destination item(s) needed by the dependency source item(s) from a user and associates the received quantity(ies) with the dependency relationship(s) set between(among) the dependency source item(s) and the dependency destination item(s).

### [Mode 17]

The process design support apparatus according to any one of modes 11 to 16;

wherein the part list holds a product, a part(s) included in the product, and a part-based configuration(s) of the product based on the part(s) in association with each other; and/or

wherein the process list holds a process sequence(s) and a process(es) included in the process sequence(s) in association with each other; and/or

wherein the resource list holds a work area(s) and a resource(s) included in the work area(s) in association with each other.

### [Mode 18]

The process design support apparatus according to mode 17; wherein the association part receives, as an associable combination of a dependency source item and a dependency destination item, at least one of:

a combination of a product or a part included in the part list and a process sequence included in the process list;

a combination of a process included in the process list and a part-based configuration included in the part list;

a combination of a process included in the process list and a resource included in the resource list; and

a combination of a product or a part included in the part list and a resource included in the resource list, from a user.

### [Mode 19]

The process design support apparatus according to any one of modes 11 to 18, comprising an impact analysis part that extracts, when a change is made to an item included in the part list, the process list, or the resource list, a different item(s) affected by the change, based on the association by the association part.

### [Mode 20]

The process design support apparatus according to any one of modes 11 to 19, comprising a display part that displays the items included in the part list, the items included in the process list, and the items included in the resource list in respective trees and displays the items associated by the association part with each other by connecting the items to each other.

### [Mode 21]

See the process design support method according to the above second aspect.

### [Mode 22]

The process design support method according to mode 21, comprising a step of associating items selected by a user with each other, at least one of the items being included in the part list and at least another one of the items being included in the process list.

### [Mode 23]

The process design support method according to mode 22, comprising steps of: receiving a dependency source item(s) included in one of the part list and the process list and a dependency destination item(s) included in the other one of the lists from a user; and setting a dependency relationship between(among) the received items.

### [Mode 24]

The process design support method according to mode 23; wherein, when a combination of a dependency source item(s) and a dependency destination item(s) received from a user is a predetermined combination, the association part sets a dependency relationship between(among) the received items.

### [Mode 25]

The process design support method according to mode 23 or 24; wherein, when the user drags and drops a first item included in a first list, which corresponds to the part list or the process list, to a second item included in a second list, one of the first item and the second item is set as a dependency source item, and the other item is set as a dependency destination item.

### [Mode 26]

The process design support method according to any one of modes 23 to 25, comprising steps of:

receiving a quantity(ies) of the dependency destination item(s) needed by the dependency source item(s) from a user; and

associating the received quantity(ies) with the dependency relationship(s) set between(among) the dependency source item(s) and the dependency destination item(s).

### [Mode 27]

The process design support method according to any one of modes 21 to 26;

wherein the part list holds a product, a part(s) included in the product, and a part-based configuration(s) of the product based on the part(s) in association with each other; and/or

wherein the process list holds a process sequence(s) and a process(es) included in the process sequence(s) in association with each other.

### [Mode 28]

The process design support method according to mode 27, comprising a step of:

receiving, as a combination of a dependency source item and a dependency destination item, at least one of: a combination of a product or a part included in the part list and a process sequence included in the process list; and a combination of a process included in the process list and a part-based configuration included in the part list, from a user.

### [Mode 29]

The process design support method according to any one of modes 21 to 28, comprising a step of extracting, when a change is made to an item included in the part list or the process list, a different item(s) affected by the change, based on the association.

### [Mode 30]

The process design support method according to any one of modes 21 to 29, comprising a step of displaying the items included in the part list and the items included in the process list in respective trees and displaying the items associated by the association part with each other by connecting the items to each other.

### [Mode 31]

The process design support method according to mode 21, comprising steps of:

holding a resource list representing a resource(s) included in a work area(s);

associating an item(s) included in the part list or the process list with an item(s) included in the resource list.

### [Mode 32]

The process design support method according to mode 31, comprising a step of associating items selected by a user with each other, the items being included in different lists among the part list, the process list, and the resource list.

### [Mode 33]

The process design support method according to mode 32, comprising steps of: receiving a dependency source item(s) and a dependency destination item(s) included in different lists among the part list, the process list, and the resource list from a user; and setting a dependency relationship between(among) the received items.

### [Mode 34]

The process design support method according to mode 33; wherein, when a combination of a dependency source item(s) and a dependency destination item(s) received from a user is a predetermined combination, the association part sets a dependency relationship between(among) the received items.

### [Mode 35]

The process design support method according to mode 33 or 34; wherein, when the user drags and drops a first item included in a first list, which corresponds to the part list, the process list, or the resource list, to a second item included in a second list, one of the first item and the second item is set as a dependency source item, and the other item is set as a dependency destination item.

### [Mode 36]

The process design support method according to any one of modes 33 to 35, comprising steps of:

receiving a quantity(ies) of the dependency destination item(s) needed by the dependency source item(s) from a user; and

associating the received quantity(ies) with the dependency relationship(s) set between(among) the dependency source item(s) and the dependency destination item(s).

### [Mode 37]

The process design support method according to any one of modes 31 to 36;

wherein the part list holds a product, a part(s) included in the product, and a part-based configuration(s) of the product based on the part(s) in association with each other; and/or

wherein the process list holds a process sequence(s) and a process(es) included in the process sequence(s) in association with each other; and/or

wherein the resource list holds a work area(s) and a resource(s) included in the work area(s) in association with each other.

### [Mode 38]

The process design support method according to mode 37, comprising a step of receiving, as a combination of a dependency source item and a dependency destination item, at least one of:

a combination of a product or a part included in the part list and a process sequence included in the process list;

a combination of a process included in the process list and a part-based configuration included in the part list;

a combination of a process included in the process list and a resource included in the resource list; and

a combination of a product or a part included in the part list and a resource included in the resource list, from a user.

### [Mode 39]

The process design support method according to any one of modes 31 to 38, comprising a step of extracting, when a change is made to an item included in the part list, the process list, or the resource list, a different item(s) affected by the change, based on the association.

### [Mode 40]

The process design support method according to any one of modes 31 to 39, comprising a step of displaying the items included in the part list, the items included in the process list, and the items included in the resource list in respective trees and displaying the items associated by the association part with each other by connecting the items to each other.

### [Mode 41]

See the program according to the above third aspect.

The entire disclosure of PTL 1 is incorporated herein by reference thereto. Variations and adjustments of the exemplary embodiments are possible within the scope of the overall disclosure (including the claims) of the present invention and based on the basic technical concept of the present invention. Various combinations and selections of various disclosed elements (including the elements in the claims, exemplary embodiments, drawings, etc.) are possible within the scope of the overall disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

1 process design support apparatus
2 part list storage part
3 process list storage part
4 resource list storage part
5 association part
6 display part
7 impact analysis part
A product
A1 intermediate item
B to D part
P to R process sequence
P1 to P3, Q1, Q2, R1, R2 process
X to Z work area
X1, Z1 equipment
X2, Y1, Z2 tool
Z3 mold

What is claimed is:

1. A process design support apparatus, comprising:
a part list storage part that holds a part list representing a part(s) included in a product;
a process list storage part that holds a process list representing a process(es) included in a process sequence(s); and
an association part that associates an item(s) included in the part list with an item(s) included in the process list.

2. The process design support apparatus according to claim 1; wherein the association part associates items selected by a user with each other, at least one of the items being included in the part list and at least another one of the items being included in the process list.

3. The process design support apparatus according to claim 2; wherein the association part receives a dependency source item(s) included in one of the part list and the process list and a dependency destination item(s) included in the other one of the lists from a user and sets a dependency relationship between(among) the received items.

4. The process design support apparatus according to claim 3; wherein, when a combination of a dependency source item(s) and a dependency destination item(s) received from a user is a predetermined combination, the association part sets a dependency relationship between(among) the received items.

5. The process design support apparatus according to claim 3; wherein, when the user drags and drops a first item included in a first list, which corresponds to the part list or the process list, to a second item included in a second list, the association part sets one of the first item and the second item as a dependency source item and the other item as a dependency destination item.

6. The process design support apparatus according to claim 3; wherein the association part receives a quantity(ies) of the dependency destination item(s) needed by the dependency source item(s) from a user and associates the received quantity(ies) with the dependency relationship(s) set between(among) the dependency source item(s) and the dependency destination item(s).

7. The process design support apparatus according to claim 1;
wherein the part list holds a product, a part(s) included in the product, and a part-based configuration(s) of the product based on the part(s) in association with each other; and/or
wherein the process list holds a process sequence(s) and a process(es) included in the process sequence(s) in association with each other.

8. The process design support apparatus according to claim 7; wherein the association part receives, as an associable combination of a dependency source item and a dependency destination item, at least one of: a combination of a product or a part included in the part list and a process sequence included in the process list; and a combination of a process included in the process list and a part-based configuration included in the part list, from a user.

9. The process design support apparatus according to claim 1, comprising an impact analysis part that extracts, when a change is made to an item included in the part list or the process list, a different item(s) affected by the change, based on the association by the association part.

10. The process design support apparatus according to claim 1, comprising a display part that displays the items included in the part list and the items included in the process list in respective trees and displays the items associated by the association part with each other by connecting the items to each other.

11. The process design support apparatus according to claim 1, comprising:
a resource list storage part that holds a resource list representing a resource(s) included in a work area(s);
wherein the association part associates an item(s) included in the part list or the process list with an item(s) included in the resource list.

12. A process design support method, comprising:
causing a computer to hold a part list representing a part(s) included in a product;
causing the computer to hold a process list representing a process(es) included in a process sequence(s); and
causing the computer to associate an item(s) included in the part list with an item(s) included in the process list.

13. A non-transitory computer-readable recording medium storing thereon a program, causing a computer to perform processing for:
holding a part list representing a part(s) included in a product;
holding a process list representing a process(es) included in a process sequence(s); and
associating an item(s) included in the part list with an item(s) included in the process list.

14. The process design support method according to claim 12; wherein association is performed on items selected by a user with each other, at least one of the items being included in the part list and at least another one of the items being included in the process list.

15. The process design support method according to claim 14; wherein the association is performed by receiving a dependency source item(s) included in one of the part list and the process list and a dependency destination item(s) included in the other one of the lists from a user and setting a dependency relationship between(among) the received items.

16. The process design support method according to claim 15; wherein, when a combination of a dependency source item(s) and a dependency destination item(s) received from a user is a predetermined combination, the association is performed by setting a dependency relationship between(among) the received items.

17. The process design support method according to claim 15; wherein, when the user drags and drops a first item included in a first list, which corresponds to the part list or the process list, to a second item included in a second list, the association is performed by setting one of the first item and the second item as a dependency source item and the other item as a dependency destination item.

18. The process design support method according to claim 15; wherein the association is performed by receiving a quantity(ies) of the dependency destination item(s) needed by the dependency source item(s) from a user and associating the received quantity(ies) with the dependency relationship(s) set between(among) the dependency source item(s) and the dependency destination item(s).

19. The process design support method according to claim 12, comprising:
holding a product, a part(s) included in the product, and a part-based configuration(s) of the product based on the part(s) in association with each other in the part list; and/or
holding a process sequence(s) and a process(es) included in the process sequence(s) in association with each other in the process list.

20. The process design support method according to claim 19; wherein the association is performed by receiving, as an associable combination of a dependency source item and a dependency destination item, at least one of: a combination of a product or a part included in the part list and a process sequence included in the process list; and a combination of a process included in the process list and a part-based configuration included in the part list, from a user.
